(19) United States
(12) Patent Application Publication
(10) Pub. No.: US 2025/0274329 A1
(43) Pub. Date: Aug. 28, 2025

(54) Techniques for Estimation and Compensation of Frequency Offset in OFDM-based Communication System

(71) Applicant: GCT Semiconductor, Inc., San Jose, CA (US)

(72) Inventors: Sang Il HAN, Seoul (KR); Jeong Min KIM, Seoul (KR); Ki Il KUM, Seoul (KR); Kyung Jin LEE, Cupertino, CA (US)

(21) Appl. No.: 19/058,607

(22) Filed: Feb. 20, 2025

(30) Foreign Application Priority Data
Feb. 21, 2024 (KR) 10-2024-0024769

(51) Int. Cl. H04L 27/26

(52) U.S. Cl. CPC H04L 27/26526; H04L 27/2605

(57) ABSTRACT

Embodiments of a reception signal processing technique in an OFDM-based communication system are disclosed. In one embodiment, a method of operating a receiver in a communication system in which at least one OFDM symbol is transmitted, each OFDM symbol including a cyclic prefix and a symbol body may comprise: performing a Fast Fourier Transform (FFT) on intervals from each of a first start position, a second start position, and a third start position included in a received signal to a length of the symbol body, to generate a first FFT signal, a second FFT signal, and a third FFT signal for a specific OFDM symbol; estimating a frequency offset for the specific OFDM symbol based on the first to third FFT signals.

### CROSS REFERENCE TO RELATED APPLICATION

The present application claims priority to Korean Patent Application No. 10-2024-0024769, filed on Feb. 21, 2024, the entire contents of which are incorporated herein for all purposes by this reference.

### BACKGROUND

### Technical Field

This disclosure relates to signal reception processing techniques in communication systems, and more particularly, some embodiments relate to methods for frequency offset estimation and compensation in OFDM-based communication systems.

### Description of the Related Art

To implement autonomous vehicles, it is essential to accurately collect information about the vehicle's surroundings and control the vehicle based on this information. Methods for collecting such information include direct sensing technologies, such as cameras, radars, and LiDAR, which are part of Advanced Driver Assistance Systems (ADAS), as well as Vehicle-to-Everything (V2X) communication, which shares the collected information with surrounding vehicles via wireless communication. V2X has become a core technology in this field.

To support V2X communication, international standards have been established, including IEEE 802.11p, known as Dedicated Short Range Communication (DSRC), 3GPP LTE (Long Term Evolution) sidelink, and NR (New Radio) sidelink. Research and implementation related to these standards are actively ongoing. Particularly, communication between vehicles traveling at high speeds faces challenges in maintaining reliable communication in rapidly changing channel conditions caused by Doppler spread.

### SUMMARY

Accordingly, there may be a need for reception signal processing techniques that can overcome such challenges, such as frequency offset estimation and/or compensation methods, or timing offset estimation and/or compensation methods.

One aspect of this disclosure provides a method of operating a receiver in a communication system in which at least one OFDM symbol is transmitted, each OFDM symbol including a cyclic prefix and a symbol body. In some embodiments, the method may comprise: performing a Fast Fourier Transform (FFT) on intervals from each of a first start position, a second start position, and a third start position included in a received signal to a length of the symbol body, to generate a first FFT signal, a second FFT signal, and a third FFT signal for a specific OFDM symbol; estimating a frequency offset for the specific OFDM symbol based on the first to third FFT signals.

In some embodiments, the first start position may be an estimated start position at which the specific OFDM symbol is located in the received signal; the second start position may be a position leading the estimated start position by a predetermined time length; and the third start position may be a position lagging behind the estimated start position by the predetermined time length.

In some embodiments, the predetermined time length may be a length of the cyclic prefix.

In some embodiments, the estimating the frequency offset may comprise: performing an Inverse Fast Fourier Transform (IFFT) only on resource blocks belonging to a specific subchannel of each of the first to third FFT signals to generate first to third IFFT signals; and estimating the frequency offset based on the first to third IFFT signals.

In some embodiments, the estimating the frequency offset based on the first to third IFFT signals may comprise estimating the frequency offset using a cyclic prefix region of the specific OFDM symbol and a region in the symbol body corresponding to the cyclic prefix region (hereinafter, a cyclic prefix corresponding region) in at least some of the first to third IFFT signals.

In some embodiments, the method may further comprise: estimating a timing offset for the received signal. In some embodiments, the estimating the frequency offset using the cyclic prefix region and the cyclic prefix corresponding region comprises: taking samples belonging to the cyclic prefix region and samples belonging to the cyclic prefix corresponding region from the second IFFT signal and the third IFFT signal, respectively, based on the estimated timing offset.

In some embodiments, the estimating the frequency offset using the cyclic prefix region and the cyclic prefix corresponding region may comprise: performing a cross-correlation on the cyclic prefix region and the cyclic prefix corresponding region; and estimating the frequency offset based on a result of the cross- correlation.

In some embodiments, the method may further comprise compensating the first IFFT signal for the estimated frequency offset.

In some embodiments, the method may further comprise performing an FFT on the first IFFT signal compensated for the frequency offset to acquire a resource block of a subchannel.

In some embodiments, a size of the FFT performed on the first IFFT signal compensated for the frequency offset may be smaller than a size of the FFT used to generate the first FFT signal.

In some embodiments, the method may further comprise performing resource demapping on the acquired resource block.

In some embodiments, the method may further comprise: estimating a timing offset for the received signal; and compensating the first IFFT signal compensated for the frequency offset for the estimated timing offset.

In some embodiments, the method may further comprise performing FFT on the first IFFT signal compensated for the timing offset to acquire a resource block of a subchannel.

In some embodiments, a size of the FFT performed on the first IFFT signal compensated for the frequency offset may be smaller than a size of the FFT used to generate the first FFT signal.

In some embodiments, the method may further comprise estimating a timing offset for the received signal.

In some embodiments, the estimating the timing offset may comprise estimating the timing offset based on at least some of the first to third FFT signals.

In some embodiments, the estimating the timing offset may comprise estimating the timing offset based on a demodulation reference signal included in the received signal.

Another aspect of this disclosure provides a receiving apparatus in a communication system in which at least one OFDM symbol is transmitted, each OFDM symbol including a cyclic prefix and a symbol body. In some embodiments, the apparatus may comprise: an FFT block configured to perform a Fast Fourier Transform (FFT) on intervals from each of a first start position, a second start position, and a third start position included in a received signal to a length of the symbol body, to generate a first FFT signal, a second FFT signal, and a third FFT signal for a specific OFDM symbol; and a frequency offset estimation block configured to estimate a frequency offset for the specific OFDM symbol based on the first to third FFT signals.

In some embodiments, the first start position may be an estimated start position at which the specific OFDM symbol is be located in the received signal; the second start position may be a position leading the estimated start position by a predetermined time length; and the third start position may be a position lagging behind the estimated start position by the predetermined time length.

In some embodiments, the frequency offset estimation block may comprise: an IFFT block configured to perform an Inverse Fast Fourier Transform (IFFT) only on resource blocks belonging to a specific subchannel of each of the first to third FFT signals to generate first to third IFFT signals; and a frequency offset calculation block configured to estimate the frequency offset based on the first to third IFFT signals.

In some embodiments, the frequency offset calculation block may be configured to estimate the frequency offset using a cyclic prefix region of the specific OFDM symbol and a region in the symbol body corresponding to the cyclic prefix region (hereinafter, a cyclic prefix corresponding region) in at least some of the first to third IFFT signals.

In some embodiments, the apparatus may further comprise a timing offset estimation block configured to estimate a timing offset for the received signal. In some embodiments, the frequency offset calculation block may comprise a segment extraction block configured to take samples belonging to the cyclic prefix region and samples belonging to the cyclic prefix corresponding region from the second IFFT signal and the third IFFT signal, respectively, based on the estimated timing offset; and a frequency offset determination block configured to perform a cross-correlation on the cyclic prefix region and the cyclic prefix corresponding region and estimate the frequency offset based on a result of the cross-correlation.

In some embodiments, the apparatus may further comprise a frequency offset compensation block configured to compensate the first IFFT signal for the estimated frequency offset.

In some embodiments, the apparatus may further comprise: a timing offset estimation block configured to estimate a timing offset for the received signal; and a timing offset compensation block configured to compensate the first IFFT signal compensated for the frequency offset for the estimated timing offset.

Yet another aspect of this disclosure provides a non-transitory recording medium storing instructions readable by a processor of an electronic device, wherein the instructions cause the processor to perform embodiments of this disclosure.

This summary is provided to introduce a selection of concepts in a simplified form that are further described in the detailed description below. This summary is not intended to identify key or essential features of the claimed subject matter, nor is it intended to be used to limit the scope of the claimed subject matter. The claimed subject matter is not limited to implementations that solve any or all disadvantages noted in any part of this disclosure. In addition to the exemplary aspects, embodiments, and features described above, further aspects, embodiments, and features will become apparent from the following detailed description and accompanying drawings.

Some embodiments of this disclosure may have an effect including the following advantages. However, since it is not meant that all exemplary embodiments should include all of them, the scope of the present disclosure should not be understood as being limited thereto.

According to some embodiments, estimation and compensation with excellent performance can be achieved even in environments with large timing offsets and/or large frequency offsets.

According to some embodiments, estimation and compensation with excellent performance can be achieved even when multiple peer-to-peer communications coexist.

According to some embodiments, frequency offset estimation and compensation can be performed on a subchannel basis rather than over the entire bandwidth.

According to some embodiments, by measuring frequency offset for each symbol, it is possible to measure up to half the subcarrier spacing, enabling estimation and compensation with excellent performance even in high-Doppler environments.

According to some embodiments, receiver complexity can be reduced by generating decimated time-domain signals using FFT and IFFT based on subchannel size, rather than the entire bandwidth.

### BRIEF DESCRIPTION OF THE DRAWINGS

FIG. 1 illustrates an example of an OFDM symbol generation block.

FIG. 2 illustrates an example of an OFDM symbol.

FIG. 3 illustrates an example of a 3GPP LTE frame structure.

FIGS. 4A and 4B illustrate examples of resource grids for LTE sidelink (SL).

FIG. 5 illustrates an example of a resource grid for NR SL.

FIGS. 6 and 7 illustrate examples of subframe structures for LTE SL and NR SL, respectively.

FIG. 8 shows Table 14.2-1 of 3GPP standard document (3GPP 36.101), which specifies performance requirements related to timing offset and frequency offset in LTE SL.

FIG. 9 shows Table 11.1.2.1.1-1 of 3GPP standard document (3GPP 36.101), which specifies performance requirements related to timing offset and frequency offset in 5G SL.

FIG. 10 shows Table 14.2-2 of 3GPP standard document (3GPP 38.101), which specifies performance requirements related to Doppler spread in LTE SL.

FIG. 11 shows Table 11.1.2.1.1-2 of 3GPP standard document (3GPP 38.101), which specifies performance requirements related to Doppler spread in 5G SL.

FIG. 12 illustrates limitations of various frequency offset estimation and channel estimation techniques.

FIG. 13 illustrates a communication system in which some embodiments of the reception signal processing method can be applied.

FIG. 14 is a flowchart illustrating some embodiments of reception signal processing.

FIG. 15 shows pseudo-code for explaining some embodiments of a reception signal processing algorithm.

FIG. 16 is a block diagram illustrating some embodiments of a reception signal processing module.

FIG. 17 illustrates FFT windows when there is a timing offset in an OFDM symbol.

FIG. 18 is a diagram illustrating DMRS REs included in the PSCCH of LTE SL.

FIG. 19 is a diagram illustrating DMRS REs included in the PSCCH of NR SL.

FIG. 20 is a diagram illustrating embodiments for regenerating time-domain signals for symbols and subchannels.

FIG. 21 is a diagram illustrating the cyclic prefix region and cyclic prefix corresponding region of the regenerated time-domain signals.

FIG. 22 is a diagram illustrating time sample offsets between the cyclic prefix region and the cyclic prefix corresponding region of the regenerated time-domain signals.

FIG. 23 shows pseudo-code for explaining some embodiments of frequency offset compensation.

FIG. 24 illustrates an example of θ_{acc} according to θ_{i,l}.

FIG. 25 illustrates cyclic shifts for timing offset compensation.

FIG. 26 is a graph illustrating the performance of the frequency offset estimation and compensation techniques of present disclosure.

### DETAILED DESCRIPTION OF THE DISCLOSURE

Since the description of the present disclosure is merely an exemplary embodiment for structural or functional description, the scope of the present disclosure should not be construed as being limited by the exemplary embodiments described in the text. That is, since exemplary embodiments may be changed in various ways and may have various forms, it should be understood that the right scope of the present disclosure includes equivalents that can realize the technical idea. In addition, the objectives or effects presented in the present disclosure may not mean that a specific exemplary embodiment should include all or only such effects, so the right scope of the present disclosure should not be understood as being limited thereto.

Meanwhile, the meaning of the terms described in the present disclosure should be understood as follows.

Terms such as “first”, “second”, and the like are intended to distinguish one component from another component, and the scope of rights should not be limited by these terms. For example, a first component may be referred to as a second component, and similarly, a second component may also be referred to as a first component.

When a component is referred to as being “connected” to another component, it may be directly connected to the other component, but it should be understood that other components may exist in the middle. On the other hand, when a component is referred to as being “directly connected” to another component, it should be understood that no other component exists in the middle. Meanwhile, other expressions describing the relationship between components, such as “between” and “immediately between” or “neighboring to” and “directly neighboring to”, should be interpreted in the same way.

Singular expressions should be understood to include plural expressions unless the context clearly indicates otherwise, and terms such as “include” or “have” are intended to designate the existence of features, numbers, steps, actions, components, parts, or combinations thereof, and should be understood not to preclude the possibilities of the existence or addition of one or more other features or numbers, steps, actions, components, parts, or combinations thereof.

In each step, identification codes (e.g., a, b, c, etc.) may be used for the convenience of explanation, and identification codes may not describe the order of each step, and each step may occur differently from the specified order unless a specific order is explicitly stated in the context. That is, each step may occur in the same order as the specified order, may be performed substantially simultaneously, or may be performed in the opposite order.

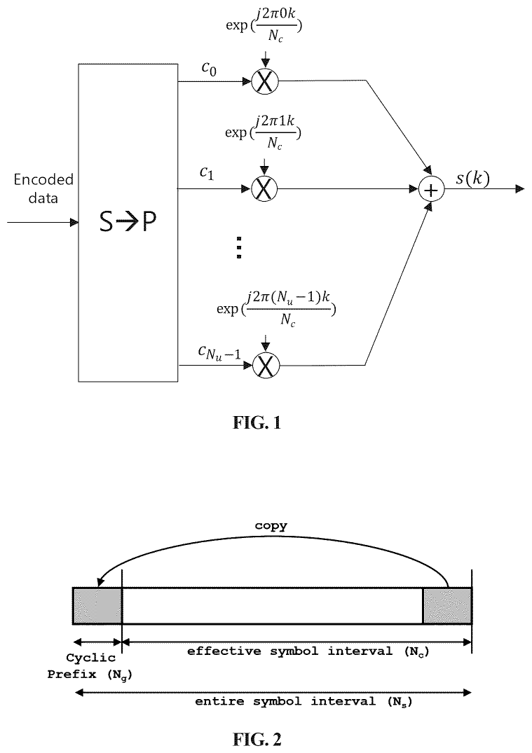

FIG. 1 illustrates an example of an OFDM symbol generation block.

Orthogonal Frequency Division Multiplexing (OFDM) is a transmission method that divides the data to be transmitted into multiple smaller data units, modulates them into mutually orthogonal subcarriers using an inverse fast Fourier transform (IFFT), and transmits them simultaneously, as illustrated in FIG. 1.

FIG. 2 illustrates an example of an OFDM symbol.

As illustrated in FIG. 2, an OFDM symbol may include a cyclic prefix (CP) and a symbol body, which is the main part of the transmission signal. The CP, formed by appending a portion of the end of the multi-carrier transmission signal (i.e., the region corresponding to the cyclic prefix within the symbol body, hereinafter referred to as the “cyclic prefix corresponding region”) to the front, can mitigate multipath interference. In 3GPP LTE/NR, when the symbol body duration N_{c} is 2048Tₛ based on the basic time unit Tₛ, the CP duration is specified as N_{g}=144Tₛ or 160Tₛ for normal CP and N_{g}=512Tₛ for extended CP.

The combination of a CP and a symbol body is referred to as CP-OFDM. In the 3GPP LTE/NR sidelink, CP-OFDM is employed.

When the number of subcarriers is Nᵤ, the CP-OFDM signal (k) at the transmitter can be expressed as Equation 1.

$$s ( k ) = \frac{1}{\sqrt{N}} {\sum }_{n = 0}^{{N}_{u} - 1} {c}_{n} exp ( \frac{j 2 π kn}{{N}_{c}} ) , - {N}_{g} \leq k \leq {N}_{c} - 1 \qquad [ Equation 1 ]$$

Some embodiments of the present disclosure relate to methods for estimating frequency offsets caused by Doppler effects during high-speed movement using the cyclic prefix (CP) in CP-OFDM. Although several embodiments are described based on the 3GPP LTE/NR environment for convenience, some embodiments of the present disclosure can be directly applied to general CP-OFDM-based systems.

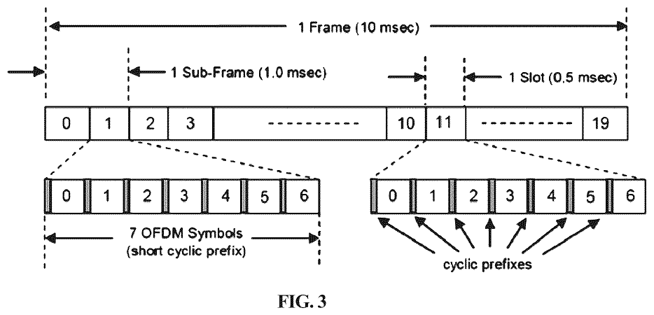

FIG. 3 illustrates an example of the 3GPP LTE frame structure.

As shown in FIG. 3, in 3GPP LTE/NR, a frame can be composed, along the time axis, of time units (e.g., subframes or slots) consisting of multiple OFDM symbols. Along the frequency axis, it can be composed of resource blocks (RBs) consisting of multiple (e.g., 12) subcarriers.

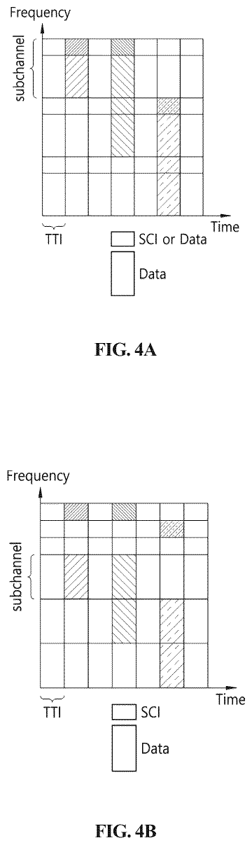

FIGS. 4A and 4B illustrate examples of the resource grid for LTE sidelink (SL).

In LTE sidelink (SL), as illustrated in FIGS. 4A and 4B, peer-to-peer communication may be performed using a pair of channels: a Physical Sidelink Control Channel (PSCCH) that carries sidelink control information (SCI) composed of two resource blocks (RBs) and a Physical Sidelink Shared Channel (PSSCH) that carries data information composed of N_{PSSCH}^{RB} . The PSSCH may be configured with varying sizes by allocating one or more subchannels. According to higher layer control signaling (RRC message), the PSCCH and PSSCH may be configured either adjacently as shown in FIG. 4A, or non-adjacently as shown in FIG. 4B. In one example, with reference to FIG. 4A, among the shaded blocks, the uppermost block corresponds to the PSCCH, while the remaining blocks correspond to the PSSCH. In another example, with reference to FIG. 4B, the uppermost shaded block corresponds to the PSCCH, while the shaded block separated from but positioned below the uppermost shaded block (i.e., in a different frequency region within the same OFDM symbol) corresponds to the PSSCH.

FIG. 5 illustrates an example of a resource grid of NR SL.

In NR SL, as illustrated in FIG. 5, PSCCH and PSSCH may each be allocated to one or more subchannels. However, unlike LTE, it comprises a two-stage SCI, wherein the PSCCH and PSSCH are configured adjacently. In one example, with reference to FIG. 5, the white box with dotted lines represents the first-stage SCI included in the PSCCH, the shaded box with dotted lines represents the second-stage SCI included in the PSSCH, and the solid-line box encompassing both the white and shaded dotted-line boxes may contain PSSCH data in the remaining resource elements excluding the aforementioned dotted-line boxes.

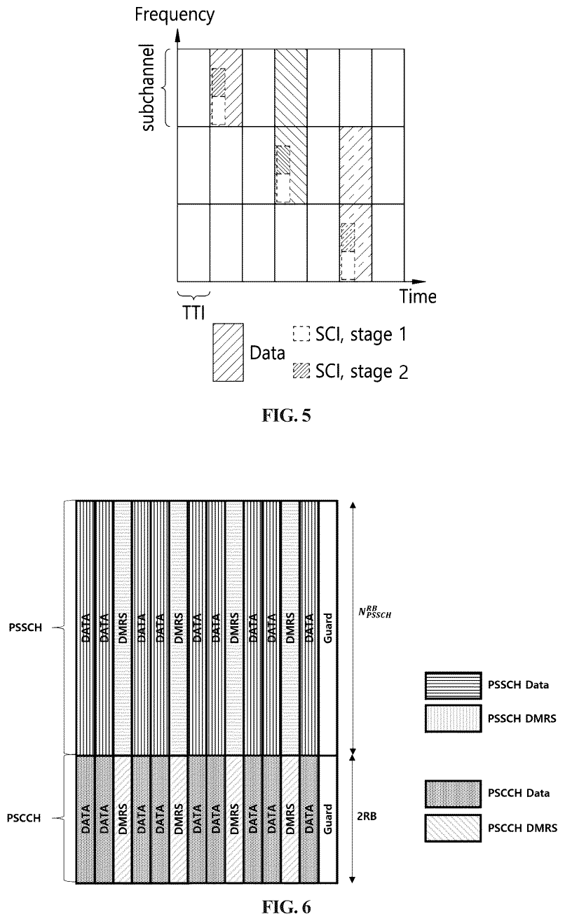

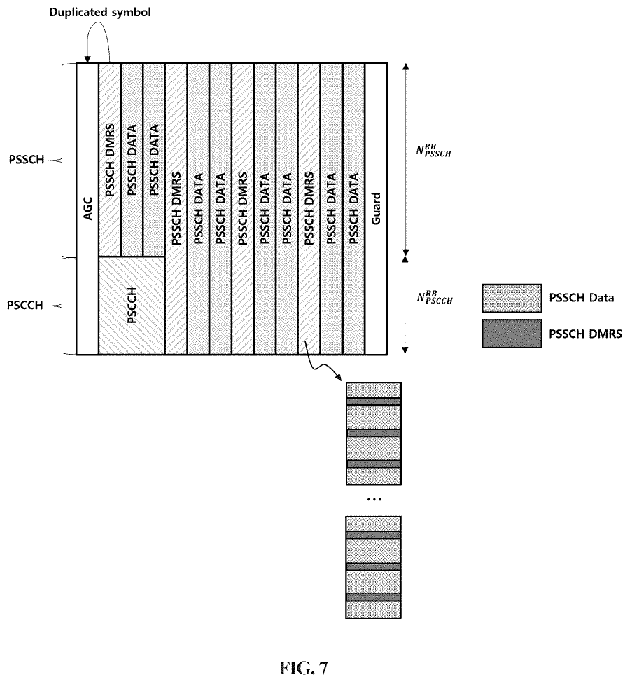

FIGS. 6 and 7 illustrate examples of subframe structures for LTE SL and NR SL, respectively.

In LTE SL, as illustrated in FIG. 6, one subframe may comprise OFDM symbols including four demodulation reference signal (DMRS) symbols and data symbols. With reference to FIG. 6, it can be observed that the OFDM symbols corresponding to DMRS symbols comprise PSSCH DMRS and PSCCH DMRS in the frequency domain. Furthermore, with reference to FIG. 6, it can be observed that the OFDM symbols corresponding to data symbols comprise PSCCH data signals and PSSCH data signals in the frequency domain.

In NR SL, the number of DMRS symbols may be variably modified through higher layer control signaling. With reference to FIG. 7, the second through fourth OFDM symbols include PSCCH, wherein said PSCCH may include PSCCH data signals and PSCCH DMRS in the corresponding frequency domain, as illustrated in FIG. 19. With reference to FIG. 7, the OFDM symbols designated as PSSCH DMRS may include PSSCH DMRS and PSSCH data signals in the frequency domain.

Common to both LTE SL and NR SL, the last symbol of the subframe is specified as a guard period, during which no signals are transmitted.

Meanwhile, when the Discrete Fourier Transform (DFT) result of a time domain signal x [k] is X[n], the DFT result of x[((k−m))_{N}], which is a circular shift, becomes

$$exp ( \frac{- j 2 π nm}{{N}_{c}} ) X [ n ] .$$

When this principle is applied to CP-OFDM signals, it can be observed that an OFDM signal with timing offset m exhibits a linear phase shift of

$$exp ( \frac{- j 2 πnm}{{N}_{c}} )$$

with respect to subcarrier index n, compared to an OFDM signal without timing offset. Some embodiments may utilize this property to estimate timing offset as described below.

Furthermore, when the aforementioned transmission signal s(k) passes through an L-tap channel h(τ; k) and a noise channel n(k), the L-tap channel h(τ; k) and the received signal x(k) after passing through the channel can be expressed by Equations 2 and 3, respectively.

$$h ( τ ; k ) = {\sum }_{l = 1}^{L} {a}_{l} ( k ) δ ( τ - {τ}_{l} ) \qquad [ Equation 2 ]$$

$$x ( k ) = s ( k ) * h ( τ ; k ) + n ( k ) = {\sum }_{l = 1}^{L} {a}_{l} ( k ) s ( k - {τ}_{l} ) + n ( k ) \qquad [ Equation 3 ]$$

In this case, when there is a normalized frequency offset ϵ₀, between the transmitter and the receiver, the received signal x(k) during the cyclic prefix region can be expressed as Equation 4, derived from Equations 1 and 3.

$${x}^{′} ( k ) = {\sum }_{l = 1}^{L} {a}_{l} ( k ) \frac{1}{\sqrt{N}} {\sum }_{n = 0}^{{N}_{u} - 1} {c}_{n} exp ( \frac{j 2 π ( k - {τ}_{l} ) ( n + {ϵ}_{o} )}{{N}_{c}} ) + n ( k ) , \\ - {N}_{g} \leq k < 0 \qquad [ Equation 4 ]$$

The corresponding cyclic prefix corresponding region can be expressed as Equation 5.

$${x}^{′} ( k + {N}_{c} ) = {\sum }_{l = 1}^{L} {a}_{l} ( k + {N}_{c} ) \frac{1}{\sqrt{N}} {\sum }_{n = 0}^{{N}_{u} - 1} {c}_{n} exp ( \frac{j 2 π ( k + {N}_{c} - {τ}_{l} ) ( n + {ϵ}_{o} )}{{N}_{c}} ) + n ( k + {N}_{c} ) , - {N}_{g} \leq k < 0 \qquad [ Equation 5 ]$$

The amplitude αₗ and normalized phase difference ϵₗ of each tap l due to Doppler effect can be independently varied. Assuming the amplitude variation within a symbol is αₗ≈1 and the normalized phase variation of each tap ϵₗ approximates to an average phase variation ϵ_{d}, certain terms included in Equation 5 can be approximated as Equation 6.

$${\sum }_{l = 1}^{L} {a}_{l} ( k + {N}_{c} ) = {\sum }_{l = 1}^{L} {β}_{l} {a}_{l} ( k ) exp ( \frac{j 2 π {N}_{c} {ϵ}_{l}}{{N}_{c}} ) \approx exp ( \frac{j 2 π {N}_{c} {ϵ}_{d}}{{N}_{c}} ) {\sum }_{l = 1}^{L} {a}_{l} ( k ) \qquad [ Equation 6 ]$$

By applying the result of Equation 6 to Equation 5, the cyclic prefix corresponding region can be expressed as Equation 7.

$${x}^{′} ( k + {N}_{c} ) \approx exp ( \frac{j 2 π {N}_{c} {ϵ}_{d}}{{N}_{c}} ) {\sum }_{l = 1}^{L} {a}_{l} ( k ) \frac{1}{\sqrt{N}} {\sum }_{n = 0}^{{N}_{u} - 1} {c}_{n} exp ( \frac{j 2 π ( k - {τ}_{l} ) ( n + {ϵ}_{o} )}{{N}_{c}} ) exp ( \frac{j 2 π {N}_{c} n}{{N}_{c}} ) exp ( \frac{j 2 π {N}_{c} {ϵ}_{o}}{{N}_{c}} ) + n ( k + {N}_{c} ) = {x}^{′} ( k ) exp ( j 2 π n ) exp ( \frac{j 2 π {N}_{c} ( {ϵ}_{o} + {ϵ}_{d} )}{{N}_{c}} ) + n ( k + {N}_{c} ) = {x}^{′} ( k ) exp ( \frac{j 2 π {N}_{c} ( {ϵ}_{o} + {ϵ}_{d} )}{{N}_{c}} ) + n ( k + {N}_{c} ) , - {N}_{g} \leq k < 0 \qquad [ Equation 7 ]$$

That is, it can be observed that a phase difference of

$$exp ( \frac{j 2 π {N}_{c} ( {ϵ}_{o} + {ϵ}_{d} )}{{N}_{c}} )$$

occurs between the cyclic prefix region and the cyclic prefix corresponding region. Some embodiments may, as described below, utilize this property to estimate frequency offset including Doppler spread.

As described above, timing offset may cause linear phase in the frequency domain signal, and frequency offset may cause linear phase in the time domain signal.

Meanwhile, the following exemplifies challenges in V2X systems to which some embodiments of the present disclosure may be applied:

First, V2X systems may encounter difficulties due to large timing and frequency offsets (hereinafter, Problem P1). In LTE/NR systems where User Equipment (UE) communicates with a base station, 1-to-N communication occurs where each UE only needs to synchronize its transmission/reception timing and frequency with the base station, making it relatively straightforward for the receiving end to correct each offset. However, in V2X systems where vehicles communicate directly peer-to-peer, N-to-N communication occurs where synchronization and frequency offsets caused by imperfect local oscillators in each vehicle's transceiver must be matched separately, potentially causing difficulties in correcting each offset. Related 3GPP standard documents (for example, 3GPP 36.101 and 38.101) specify in their performance requirements that timing offset between vehicles may be permitted up to T_{g}/2−12Tₛ, and frequency offset between vehicles may be permitted up to ±600 Hz.

FIG. 8 shows Table 14.2-1 of 3GPP standard document (3GPP 36,101), which specifies performance requirements related to timing offset and frequency offset in LTE SL.

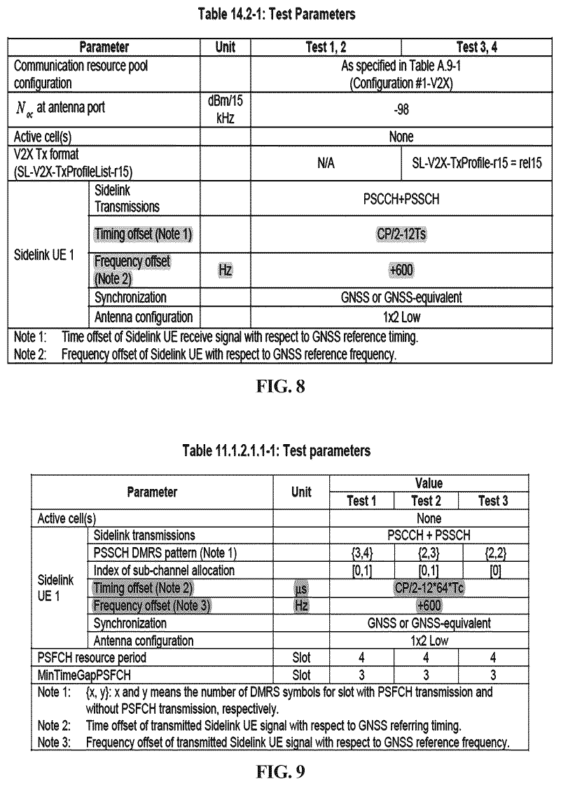

FIG. 9 shows Table 11.1.2.1.1-1 of 3GPP standard document (3GPP 38,101), which specifies performance requirements related to timing offset and frequency offset in 5G SL.

With reference to FIGS. 8 and 9, the requirements for timing offset (i.e., synchronization error) and frequency offset (i.e., frequency error) in each system can be identified.

Second, V2X systems may encounter difficulties due to different frequency offsets and timing offsets for each subchannel (hereinafter, Problem P2). This is because communication may occur between different vehicles in each subchannel. Therefore, for estimation and/or compensation of offsets (frequency offset and/or timing offset) in V2X systems, each subchannel may need to be processed independently.

Third, V2X systems may encounter difficulties due to large Doppler spread (hereinafter, Problem P3). In communications between high-speed vehicles, channel response changes rapidly over time due to large Doppler spread, and transmission/reception must be performed smoothly even in such channels. Additionally, in V2X systems, Inter-carrier interference (ICI) may occur due to Doppler spread and frequency offset breaking the orthogonality between OFDM subcarriers, and this ICI problem also needs to be effectively resolved. Related 3GPP standard documents (for example, 3GPP 36,101 and 38.101) specify performance requirements that support a maximum Doppler frequencies of up to 2700 Hz.

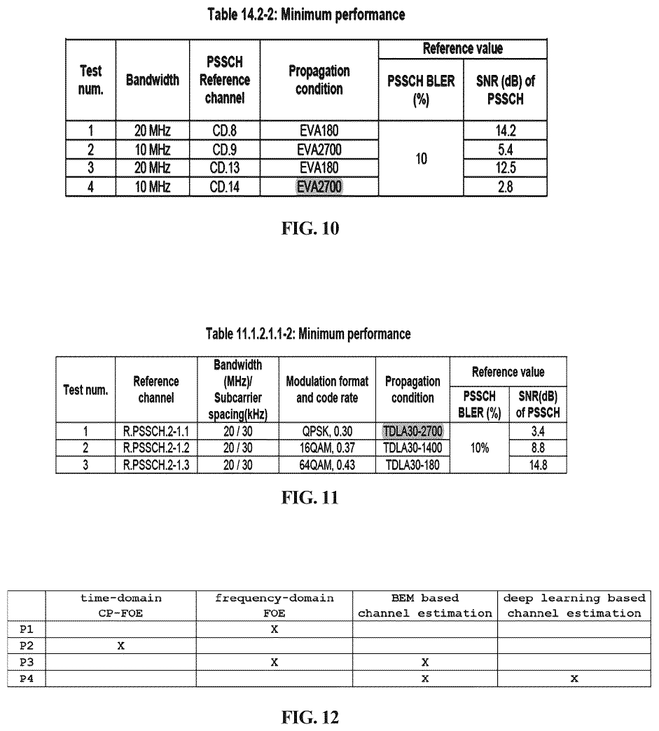

FIG. 10 shows Table 14.2-2 of 3GPP standard document (3GPP 36,101), which specifies performance requirements related to Doppler spread in LTE SL.

For example, in FIG. 10, the propagation condition EVA2700 specified in Test num. 4 represents the EVA (extended vehicular A model) condition for multi-path and a maximum Doppler spread of 2700 Hz.

FIG. 11 shows Table 11.1.2.1.1-2 of 3GPP standard document (3GPP 38,101), which specifies performance requirements related to Doppler spread in 5G SL.

For example, in FIG. 11, the propagation condition TDLA30-2700 specified in Test num. 1 represents the TDLA30 (Tapped Delay Line A) condition for multi-path and a maximum Doppler spread of 2700 Hz.

Fourth, V2X systems may face challenges (hereinafter, P4 problem) requiring guaranteed low implementation complexity and low processing delay. Low processing delay may be essential for urgent data transmission, such as vehicle collision prevention. Additionally, low-complexity algorithms may be necessary for implementation in chips with limited heat generation and size constraints.

Various studies have been conducted to address the temporal variations of channels caused by Doppler spread, focusing on frequency offset and channel estimation.

First, there is a technique for measuring frequency offset in the time domain using CP (hereinafter referred to as the time-domain CP-FOE (Frequency Offset Estimation) method). As described earlier, the time-domain signal generates a linear phase proportional to the frequency offset. Therefore, this method calculates the cross-correlation between the CP signal and the corresponding symbol body signal to measure the phase difference and, consequently, the frequency offset. However, as mentioned in the P2 problem, each received signal in sidelink communications consists of N-to-N communication signals, where each subchannel has a different frequency offset. As a result, it is challenging to find the corresponding frequency offset for each signal in the time-domain signal.

Second, there is a method (hereinafter referred to as the frequency-domain FOE (Frequency Offset Estimation) method) that measures the phase difference and corresponding frequency offset by calculating the cross-correlation between symbols containing reference signals. The measured frequency offset can then be used to estimate the frequency offset of data symbols through interpolation. This method can measure the frequency offset within the allocated frequency domain, potentially addressing the P2 problem. However, as mentioned in the P3 problem, if there is a large frequency offset in addition to Doppler spread, interpolation errors increase. Furthermore, for data symbols outside the subframe, where interpolation is not feasible, performance degradation becomes unavoidable due to errors caused by extrapolation. For example, adding a frequency offset of 600 Hz to the previously mentioned Doppler spread of 2700 Hz can result in a maximum offset of 3300 Hz. In LTE sidelink (SL), when the distance between DMRS symbols is 3 symbols with a subcarrier spacing (SCS) of 15 kHz, the measurable frequency offset is limited to

$$\pm \frac{15 KHz}{3 symbol * 2} = \pm 2500 Hz ,$$

which does not reach the maximum frequency offset.

Third, in the transform domain, there is a method (hereinafter referred to as the BEM-based channel estimation method) that detects the characteristics of reference symbols using a basis expansion model (BEM) and extends them to data symbols through interpolation or Kalman filtering. This method leverages the fact that channels can be modeled with fewer parameters in the transform domain. However, this method requires large-scale matrix operations with a complexity of O((Nᵤ*N_{sym})³). As a result, it fails to meet the low-complexity requirements (i.e., the P4 problem) and suffers from performance degradation under large Doppler spreads, as mentioned in the P3 problem, due to interpolation errors.

Fourth, there is a method (hereinafter referred to as the deep learning-based channel estimation method) that applies deep learning-based channel estimation to channels varying in both time and frequency domains, such as sidelink channels. However, this method has high implementation complexity, with complexity O(h*w*l*Nᵤ* N_{sym}), where h is the height, w is the width of the convolutional filter, and l is the number of layers. Additionally, it relies solely on reference symbols as input. Moreover, techniques with relatively lower complexity, such as long short-term memory (LSTM) models, require reference symbols to follow the symbols being estimated. Unlike LTE, which continuously provides reference signals, LTE/NR sidelink may face difficulties applying data transmissions at the subframe level, resulting in processing delays that fail to address the P4 problem.

FIG. 12 illustrates limitations of various frequency offset estimation and channel estimation techniques. Referring to FIG. 12, the limitations of the aforementioned methods are exemplified. For instance, the time-domain CP-FOE method may have limitations in addressing the P2 problem.

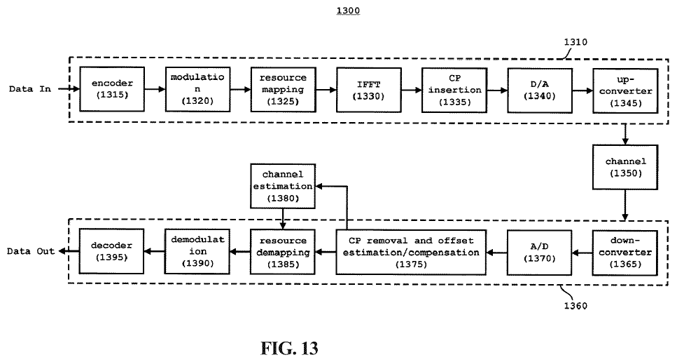

FIG. 13 illustrates a communication system in which some embodiments of the reception signal processing method can be applied.

While FIG. 13 illustrates an exemplary configuration of a CP-OFDM communication system, various embodiments of the present disclosure may be applied to communication systems having configurations different from the structure shown in FIG. 13.

Referring to FIG. 13, the CP-OFDM communication system (1300) may comprise a transmitter (1310), a channel (1350), and a receiver (1360).

In some embodiments, the transmitter (1310) and receiver (1360) may each be a UE (e.g., a V2X-based UE performing sidelink communication). In other embodiments, the transmitter (1310) and receiver (1360) may be a base station and a UE, or a UE and a base station.

Referring to FIG. 13, the transmitter (1310) may comprise an encoder block (1315), a modulation block (1320), a resource mapping block (1325), an IFFT block (1330), a CP insertion block (1335), a D/A block (1340), and an up-converter block (1345).

The encoder block (1315) may encode input data (e.g., channel coding) and output the encoded data.

The modulation block (1320) may map each encoded data (e.g., binary bits) or groups of encoded data to modulation symbols (e.g., QPSK symbols).

The resource mapping block (1325) may provide the modulation symbols to the IFFT block (1330) so that each modulation symbol is positioned at the corresponding resource (e.g., subcarriers).

The IFFT block (1330) may perform an IFFT transformation on the input modulation symbols to generate the symbol body of each OFDM symbol.

The CP insertion block (1335) may insert the corresponding CP at the beginning of the symbol body of each OFDM symbol received as input.

The CP-inserted OFDM symbols (i.e., CP-OFDM symbols) may be converted into analog signals through the D/A block (1340) and transmitted over the wireless communication channel (1350) via the up-converter block (1345) and at least one transmit antenna (not shown).

Referring to FIG. 13, the receiver (1360) may comprise a down-converter block (1365), an A/D block (1370), a CP removal and offset estimation/compensation block (1375), a channel estimation block (1380), a resource demapping block (1385), a demodulation block (1390), and a decoder (1395).

The down-converter block (1365) may generate a baseband signal by frequency down-converting the signal received through at least one receiving antenna (not shown) to baseband.

The A/D block (1370) may convert the analog baseband signal received from the down-converter block (1365) into a digital baseband signal.

The CP removal and offset estimation/compensation block (1375) may receive the digital baseband signal, perform CP removal and offset estimation/compensation, and provide the processed signal to the channel estimation block (1380) and the resource demapping block (1385). An example of the digital baseband signal input to the CP removal and frequency offset estimation/compensation block (1375) may be approximated as expressed in Equation 3.

The channel estimation block (1380) may perform channel estimation based on the output of the CP removal and frequency offset estimation/compensation block (1375) (e.g., sample values corresponding to pilot symbols for channel estimation).

The resource demapping block (1385) may extract demodulation symbols included in the corresponding resource (e.g., the subcarrier location of the corresponding subchannel) based on the channel estimation results and the offset-compensated signal, and provide the extracted symbols to the demodulation block (1390).

The demodulation block (1390) may detect (i.e., demap) the data corresponding to each input demodulation symbol and provide it to the decoder (1395).

The decoder (1395) may decode (e.g., perform channel decoding) the input data stream to recover the data transmitted by the transmitter (1310).

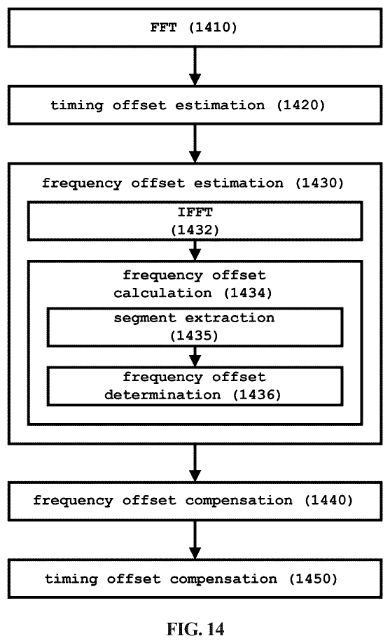

FIG. 14 is a flowchart illustrating some embodiments of reception signal processing.

The embodiments of reception signal processing illustrated in FIG. 14 may be performed by a receiver that receives CP-OFDM signals (e.g., a UE, a base station, or the receiver shown in FIG. 13) or by specific blocks of such a receiver (e.g., a baseband processing module, or the CP removal and offset estimation/compensation block (1375) shown in FIG. 13).

For convenience, the following description assumes that the CP removal and offset estimation/compensation block (1375) of FIG. 13 performs the reception signal processing illustrated in FIG. 14. However, in several embodiments, the CP removal and offset estimation/compensation block (1375) is referred to as a reception signal processing module to explain the embodiments.

In some embodiments, as illustrated in FIG. 14, the reception signal processing module may comprise an FFT block (S1410), a timing offset estimation block (S1420), a frequency offset estimation block (S1430), a frequency offset compensation block (S1440), and a timing offset compensation block (S1450). In other embodiments, the reception signal processing module may comprise only some of the FFT block (S1410), timing offset estimation block (S1420), frequency offset estimation block (S1430), frequency offset compensation block (S1440), and timing offset compensation block (S1450).

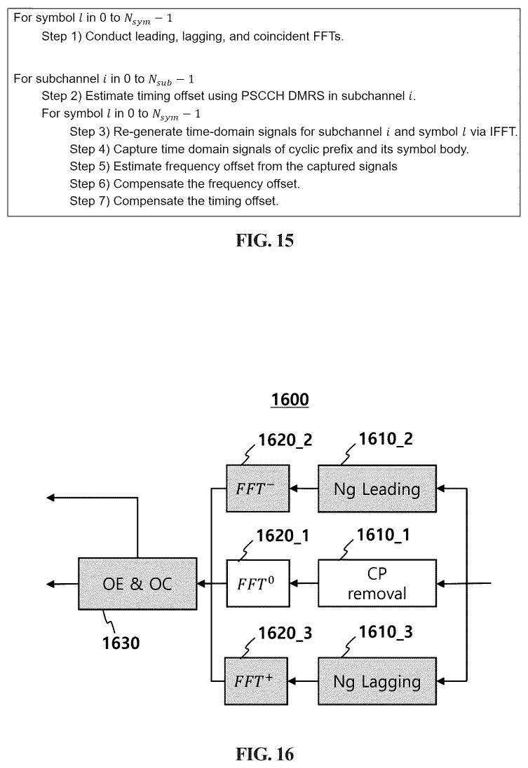

FIG. 15 shows pseudo-code for explaining some embodiments of a reception signal processing algorithm.

The pseudocode in FIG. 15 assumes that the received signal comprises a subframe containing at least N_{sym} OFDM symbols (with OFDM symbol indices 0, 1, . . . , N_{sym}−1), and the subframe may include subchannel i in the frequency domain. For example, based on the pseudocode illustrated in FIG. 15, the reception signal processing module may estimate and/or compensate for offsets (timing offsets and/or frequency offsets) for signals related to a target subchannel i of the receiver.

Steps 1, 2, 3, 4, 5, 6, and 7 of FIG. 15 may correspond to S1410, S1420, S1432, S1435, S1436, S1440, and S1450, respectively, according to some embodiments described below.

FIG. 16 is a block diagram illustrating some embodiments of a reception signal processing module.

Referring to FIG. 16, the reception signal processing module (1600) may comprise first to third FFT target sample extraction blocks (1610_1, 1610_2, 1610_3), first to third FFT blocks (1620_1, 1620_2, 1620_3), and an offset estimation/compensation block (1630).

In some embodiments, the first to third FFT target sample extraction blocks (1610_1, 1610_2, 1610_3) and the first to third FFT blocks (1620_1, 1620_2, 1620_3) in FIG. 16 may correspond to the FFT block (S1410) in FIG. 14.

In some embodiments, the offset estimation/compensation block (1630) in FIG. 16 may correspond to at least some of the following blocks in FIG. 14: the timing offset estimation block (S1420), the frequency offset estimation block (S1430), the frequency offset compensation block (S1440), and the timing offset compensation block (S1450).

In some embodiments, the FFT block (S1410) may generate first FFT signal, second FFT signal, and third FFT signal for a specific OFDM symbol by performing FFT on intervals from first start position, second start position, and third start position, respectively, included in said received signal up to the length of the symbol body.

In some embodiments, the FFT block (S1410) may comprise the first to third FFT target sample extraction blocks (1610_1, 1610_2, 1610_3) and first to third FFT blocks (1620_1, 1620_2, 1620_3).

In some embodiments, the first start position may include the estimated start position of the specific OFDM symbol within the received signal. The second start position may be located a predetermined time length earlier than the estimated start position, and the third start position may be located a predetermined time length later than the estimated start position.

In some embodiments, the predetermined time length may be the length of the cyclic prefix (CP).

In a typical OFDM receiver, FFT operations are performed only on the symbol body after removing the CP. However, in sidelink communications, timing offsets between vehicles may be allowed up to ±CP/2−12Tₛ, requiring additional measures to address such timing offsets.

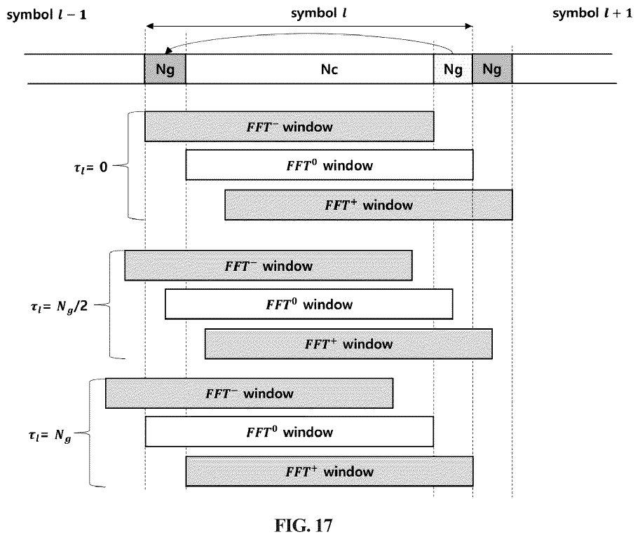

FIG. 17 illustrates FFT windows when there is a timing offset in an OFDM symbol.

In FIG. 17, when the timing offset τₗ in OFDM symbol l is 0, τₗ is N_{g}/2, and τₗ is N_{g}, the coincident FFT window (FFT0), the leading FFT window (FFT−), and the lagging FFT window (FFT+) are shown.

Since a timing offset can occur up to a maximum of ±CP/2−12Tₛ, the coincident FFT window FFT0 is operated to be in the middle of the CP so that it does not deviate from the CP even if a timing offset occurs. Additionally, in the proposed method, extra FFT operations are performed using FFT− and FFT+, which shift the FFT window by −N_{g} and +N_{g} relative to FFT0, respectively. This approach ensures that the FFT windows include the cyclic prefix (CP) region and the corresponding cyclic prefix region used for frequency offset estimation, even in the presence of timing offsets.

The three FFT results obtained in this manner may be used in the offset estimation/compensation block (1630) to estimate and compensate for timing offsets and frequency offsets, including Doppler spread.

For simplicity, this document assumes that the timing offset does not change within a subframe, while the frequency offset changes for each symbol. For example, under this assumption, some embodiments may perform frequency offset estimation for each OFDM symbol.

Returning to FIG. 14, as illustrated, the timing offset estimation block (S1420) may estimate the timing offset of the received signal.

In some embodiments, the timing offset estimation block (S1420) may be included in the offset estimation/compensation block (1630) shown in FIG. 16.

In some embodiments, the timing offset estimation block (S1420) may estimate the timing offset based on at least some of the first to third FFT signals.

In some embodiments, the timing offset estimation block (S1420) may estimate the timing offset based on a demodulation reference signal included in the received signal. For example, in a sidelink system, the timing offset estimation block (S1420) may estimate the timing offset using the PSCCH DMRS associated with subchannel i.

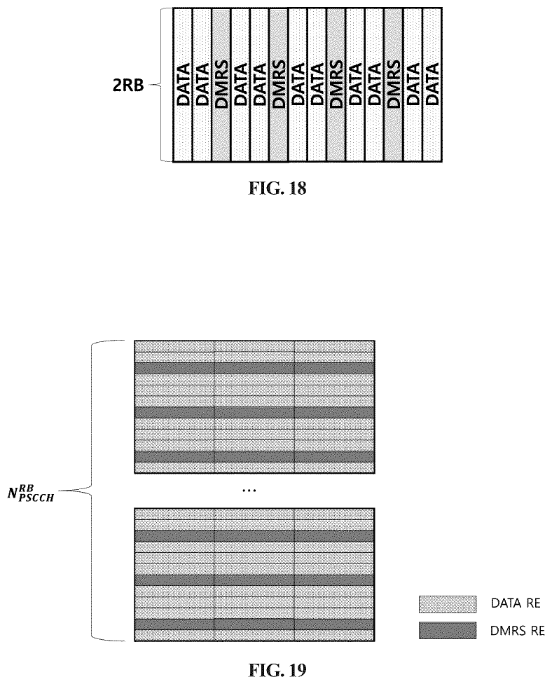

FIG. 18 is a diagram illustrating DMRS REs included in the PSCCH of LTE SL.

FIG. 19 is a diagram illustrating DMRS REs included in the PSCCH of NR SL.

As described earlier, when a timing offset τ occurs while taking an FFT window, a linear phase shift of

$$\frac{2 π \cdot τ}{{N}_{FFT}} \cdot k$$

may occur in the frequency domain at an RE with index k. Therefore, by performing an IFFT on the descrambled DMRS, a peak may be observed at t in the time domain, allowing the timing offset to be detected.

In LTE SL, as shown in FIG. 18, 24 DMRS REs are distributed across 4 DMRS symbols. In NR SL, as shown in FIG. 19, the PSCCH consists of ·N_{PSCCH}^{RB} DMRS REs distributed across 2 or 3 PSCCH symbols.

In some embodiments, the reception signal processing module may perform IFFT for each DMRS symbol, accumulate the results, and detect the timing offset by finding the index with the maximum absolute value.

In some embodiments, the reception signal processing module may perform IFFT with the smallest possible size for each subchannel to reduce implementation complexity. For example, if the number of REs belonging to subchannel i is denoted as N_{RE}ⁱ, the IFFT size N_{IFFT}ⁱ can be expressed by Equation 8.

$${N}_{IFFT}^{i} = 2 ⌈ log 2 ( {N}_{RE}^{i} ) ⌉ \qquad [ Equation 8 ]$$

That is, the smallest power of 2 that is larger than the number of REs in the subchannel may be selected as the IFFT size N_{IFFT}ⁱ.

As illustrated in FIG. 17, when a timing offset τᵢ occurs while applying an FFT window to the received signal, the timing offset τ′ᵢ of the signal resulting from performing IFFT on the FFT output can be expressed as Equation 9.

$${τ}_{i}^{′} = {τ}_{i} \cdot \frac{{N}_{IFFT}^{i}}{{N}_{FFT}} \qquad [ Equation 9 ]$$

In other words, τ′ᵢ is scaled by

$$\frac{{N}_{IFFT}^{i}}{{N}_{FFT}}$$

based on τᵢ.

Returning to FIG. 14, in some embodiments, the frequency offset estimation block (S1430) may estimate the frequency offset for a specific OFDM symbol based on the first to third FFT signals, as illustrated.

In some embodiments, as illustrated in FIG. 14, the frequency offset estimation block (S1430) may comprise an IFFT block (S1432) and a frequency offset calculation block (S1434).

In some embodiments, the IFFT block (S1432) may perform IFFT only for resource blocks belonging to the specific subchannel of each of the first to third FFT signals, generating first to third IFFT signals. For example, through the IFFT block (S1432), a time-domain signal for a specific subchannel (e.g., subchannel i) of a specific OFDM symbol (e.g., OFDM symbol l) may be reconstructed.

In some embodiments, the IFFT block (S1432) may takes only the resource blocks (RBs) belonging to subchannel i from FFTₗ⁻, FFTₗ⁰, FFTₗ⁺obtained in block S1410 for OFDM symbol l as IFFT input. Before performing IFFT, the center of subchannel i may be aligned with the DC position of the IFFT input. The IFFT results are denoted as IFFT_{i,l}⁻, IFFT_{i,l}⁰, IFFT_{i,l}⁺.

In some embodiments, the reception signal processing module may use N_{IFFT}ⁱ calculated from Equation 8 as the IFFT size.

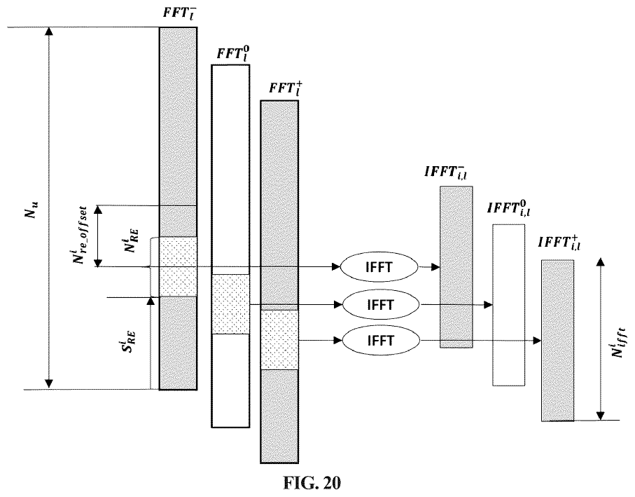

FIG. 20 is a diagram illustrating embodiments for regenerating time-domain signals for symbols and subchannels.

As shown in FIG. 20, when S_{RE}ⁱ represents the starting RE index of subchannel i, the offset between the FFT DC and the IFFT DC, denoted as N_{re_offset}ⁱ, can be expressed by Equation 10.

$${N}_{{re}_{offset}}^{i} = \frac{( {N}_{u} - {N}_{R E}^{i} )}{2} - {S}_{R E}^{i} \qquad [ Equation 10 ]$$

The IFFT_{i,l}⁻, IFFT_{i,l}⁰, IFFT_{i,l}⁺obtained in this way can be regarded as a signal obtained by adding a frequency offset N_{re_offset}ⁱ to the

$$\frac{{N}_{IFFT}^{i}}{{N}_{FFT}}$$

times decimated time-domain signal for subchannel i.

Referring again to FIG. 14, in some embodiments, as illustrated, the frequency offset calculation block (S1434) may estimate the frequency offset using the cyclic prefix (CP) region and the cyclic prefix corresponding region of the specific OFDM symbol, based on at least some of the first to third IFFT signals.

In some embodiments, as illustrated in FIG. 14, the frequency offset calculation block (S1434) may comprise a segment extraction block (S1435) and a frequency offset determination block (S1436).

In some embodiments, the segment extraction block (S1435) may extract samples belonging to the cyclic prefix region and the cyclic prefix corresponding region from the second and third IFFT signals, respectively, based on the estimated timing offset.

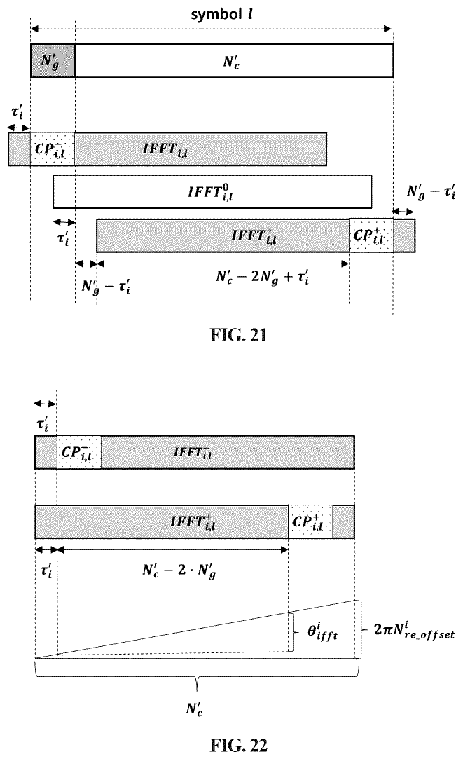

FIG. 21 is a diagram illustrating the cyclic prefix (CP) region and the cyclic prefix corresponding region of the reconstructed time-domain signals.

FIG. 21 shows the temporal positions of the time-domain signals IFFT_{i,l}⁻, IFFT_{i,l}⁰, IFFT_{i,l}⁺generated in block S1432, based on the timing offset τᵢ estimated in block S1420.

In FIG. 21, the cyclic prefix region of the reconstructed time-domain signal is denoted as CP_{i,l}⁻, and the cyclic prefix corresponding region is denoted as CP_{i,l}⁺.

As described earlier, the time-domain signals IFFT_{i,l}⁻, IFFT_{i,l}⁰, IFFT_{i,l}⁺are decimated versions of the received signal by a factor of

$$\frac{{N}_{IFFT}^{i}}{{N}_{FFT}} .$$

Thus, the CP length N′_{g} and the symbol body length N′_{c} of IFFT_{i,l}⁻, IFFT_{i,l}⁰, IFFT_{i,l}⁺have values scaled accordingly,

$${N}_{g}^{′} = \frac{{N}_{IFFT}^{i}}{{N}_{F F T}} \cdot {N}_{g} and {N}_{c}^{′} = \frac{{N}_{IFFT}^{i}}{{N}_{F F T}} \cdot {N}_{c} = {N}_{IFFT}^{i} ,$$

respectively.

The cyclic prefix region (CP_{i,l}⁻) is extracted from the signal starting at a point delayed by τ′ᵢ from the beginning of IFFT_{i,l}⁻and extending for a length of N′_{g}.

The cyclic prefix corresponding region (CP_{i,l}⁻) corresponding to the cyclic prefix region (CP_{i,l}⁻) is extracted from the signal starting at a point delayed by N′_{c}−2·N′_{g}+τ′ᵢ from the beginning of IFFT_{i,l}⁺and extending for a length of N′_{g}.

Returning to FIG. 14, in some embodiments, as illustrated, the frequency offset determination block (S1436) may determine the frequency offset based on the cross-correlation result between the samples in the cyclic prefix region and the samples in the cyclic prefix corresponding region.

In some embodiments, the reception signal processing module may calculate the cross-correlation σ_{i,l} between CP_{i,l}⁻and CP_{i,l}⁺for symbol l using Equation 11.

$${σ}_{i , l} = {\sum }_{k = 1}^{{N}_{g}^{′}} C {P}_{i , l}^{+} ( k ) \cdot {{CP}_{i , l}^{-} ( k )}^{*} \qquad [ Equation 11 ]$$

In some embodiments, the reception signal processing module may calculate the phase σ_{i,l} from the cross-correlation value using Equation 12.

$${Θ}_{i , l} = argtan ( \frac{im ( {σ}_{i , l} )}{re ( {σ}_{i , l} )} ) \qquad [ Equation 12 ]$$

In Equations 11 and 12, re(α) and im(α) represent the real and imaginary parts of α, respectively, and α* denotes the conjugate of α.

The phase Θ_{i,l} also reflects the phase rotation σ_{ifft}ⁱ caused by the offset N_{re_offset}ⁱ between the DC positions in the FFT and IFFT described in block S1432. Therefore, to obtain the phase rotation θ_{i,l} caused by the frequency offset of symbol l, the phase rotation θ_{ifft}ⁱ must be removed from Θ_{i,l}.

FIG. 22 is a diagram illustrating the time sample offset between the cyclic prefix region and the cyclic prefix corresponding region of the reconstructed time-domain signal.

As described earlier, N_{re_offset}ⁱ introduces a linear phase shift of

$$2 π \frac{{N}_{re\_offset}^{i}}{{N}_{c}^{′}}$$

per time sample. As shown in FIG. 22, the time sample difference between CP_{i,l}⁻(k) and CP_{i,l}⁺in the IFFT is N′_{c}−2·N′_{g}. Thus, the phase rotation θ_{ifft}ⁱ can be calculated using Equation 13.

$${θ}_{ifft}^{i} = 2 n \frac{{N}_{re\_offset}^{i}}{{N}_{c}^{′}} ( {N}_{c}^{′} - 2 \cdot {N}_{g}^{′} ) \qquad [ Equation 13 ]$$

The phase rotation θ_{i,l} can be determined using the result of Equation 13 and Equation 14.

$${θ}_{i , l} = {Θ}_{i , l} - {θ}_{ifft}^{i} = {Θ}_{i , l} - 2 π \frac{{N}_{re\_offset}^{i}}{{N}_{c}^{′}} ( {N}_{c}^{′} - 2 \cdot {N}_{g}^{′} ) \qquad [ Equation 14 ]$$

Returning to FIG. 14, in some embodiments, as illustrated, the frequency offset compensation block (S1440) may perform frequency offset compensation on the received signal based on the estimated frequency offset.

In some embodiments, the frequency offset compensation block (S1440) may compensate the estimated frequency offset for the first IFFT signal.

As described earlier, frequency offset appears as a linear phase rotation in the time domain. To compensate for this, the phase must be rotated in the opposite direction.

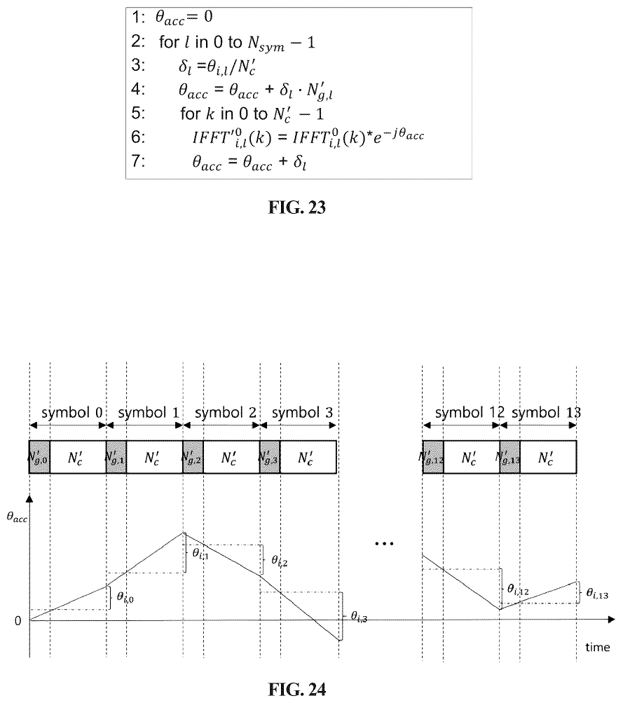

FIG. 23 shows pseudo-code for explaining some embodiments of frequency offset compensation.

For example, the pseudocode in FIG. 23 demonstrates the process of compensating the frequency offset θ_{i,l} estimated in block S1436 for IFFT_{i,l}⁰ to obtain IFFT′_{i,l}⁰.

As described earlier in FIG. 21, since the time sample difference between CP_{i,l}⁻and CP_{i,l}⁺is N′_{c}, the phase rotation per time sample δ_{i,l} can be calculated as shown in line 3 of the pseudocode in FIG. 23.

Additionally, since linear phase rotation also occurs in the cyclic prefix region, this effect must be accounted for, as indicated in line 4 of the pseudocode in FIG. 23.

FIG. 24 illustrates an example of θ_{acc} according to θ_{i,l}.

Returning again to FIG. 14, in some embodiments, as illustrated, the timing offset compensation block (S1450) may compensate for the timing offset in the received signal. In some embodiments, the timing offset compensation block (S1450) may compensate the estimated timing offset for the frequency-offset-compensated first IFFT signal.

In some embodiments, the reception signal processing module may obtain IFFT″_{i,l}⁰, which is compensated for the timing offset, by performing a cyclic shift on IFFT′_{i,l}⁰, which is compensated for the frequency offset, in the opposite direction by the timing offset τ′ᵢ obtained in the S1410 block, as shown in Equation 15.

$${IFFT}_{i , l}^{″0} ( ( k - {τ}_{i}^{′} + {N}_{ifft}^{i} ) \% {N}_{ifft}^{i} ) = {IFFT}_{i , l}^{′0} ( k ) \qquad [ Equation 15 ]$$

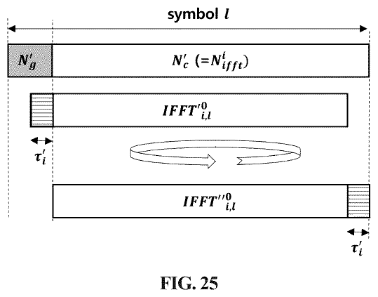

FIG. 25 illustrates cyclic shifts for timing offset compensation.

In some embodiments, after obtaining the timing-offset-compensated signal IFFT″_{i,l}^{o}, the reception signal processing module may obtain the RBs of subchannel i by performing an FFT with size N_{IFFT}ⁱ in the reverse process of the S1432 block.

In some embodiments, the RBs obtained through this process may be used as inputs to subsequent signal processing blocks, such as the channel estimation block and/or the resource demapping block illustrated in FIG. 13.

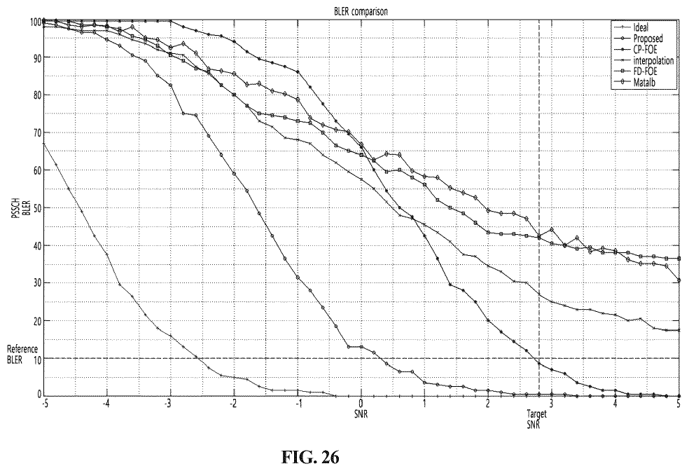

FIG. 26 is a graph illustrating the performance of the frequency offset estimation and compensation techniques of present disclosure.

More specifically, FIG. 26 shows the results of a simulation comparing the PSSCH BLER (Block Error Rate) performance for six different cases, including the proposed method (“Proposed”) and other methods such as “Interpolation.”

The simulation environment follows the PSSCH requirement test num. 4 defined in Section 14.2 of the 3GPP standard document TS 38.104. Timing and frequency offsets were set to CP/2−12Tₛ and 600 Hz, respectively, with channel conditions based on EVA2700 using reference channel cd.14.

For channel estimation, a moving average over 12 REs in the frequency domain and linear interpolation in the time domain were applied.

In FIG. 26, “Ideal” refers to a case where a frequency offset including Doppler spread is estimated from an ideal channel to which no noise is added, and a frequency offset and a timing offset are compensated as in the S1440 block and the S1450 block.

Also, in FIG. 26, “Proposed” refers to a case where the offset estimation and compensation technique of the present disclosure is used, and “CP-FOE” refers to a case where a frequency offset is estimated by a time domain based CP-FOE, but a frequency offset and a timing offset are compensated as in the S1440 block and the S1450 block.

Also, in FIG. 26, “Interpolation” refers to a case where frequency offset estimation and compensation are not performed, and “FD-FOE” refers to a case where a frequency offset is estimated with 4 DMRS symbols in the frequency domain, and a frequency offset and a timing offset are compensated as in the S1440 block and the S1450 block.

Also, in FIG. 26, “Matlab” refers to a case where the LTE SL simulation model included in Matlab™ of Mathworks is changed to test num. 4 and a frequency offset of 600 Hz is added.

Referring to FIG. 26, it can be seen that only “Ideal”, “Proposed”, and “CP-FOE” satisfy the PSSCH BLER of 10% at the target SNR of 2.8 dB with margins of 5.4 dB, 2.5 dB, and 0.1 dB, respectively.

Comparing “Proposed” and “CP-FOE”, the “Proposed” method can remove noises belonging to RBs not included in the subchannel, but “CP-FOE” estimates the frequency offset including noises belonging to all RBs, so this performance difference can occur.

Comparing “Proposed” and “FD-FOE,” the “Proposed” method estimates frequency offsets for each symbol, whereas FD-FOE estimates offsets only between symbol pairs (e.g., {symbol 2, symbol 5}, {symbol 5, symbol 8}, and {symbol 8, symbol 11}), resulting in larger estimation errors. Consequently, compensation based on FD-FOE may perform worse than “Interpolation.”

Comparing “Proposed,” “Interpolation,” and “Matlab,” large frequency offsets degrade performance not only due to channel estimation errors but also because subcarrier orthogonality is lost, causing ICI (Inter-Carrier Interference). Since “Interpolation” and “Matlab” cannot compensate for these effects, their BLER does not sufficiently decrease even at higher SNRs, failing to meet performance requirements, as illustrated in FIG. 26.

The aforementioned apparatus may be implemented using hardware components, software components, and/or a combination of hardware and software components. For example, the apparatus and components described in the embodiments may be implemented using one or more general-purpose or special-purpose computers, such as a processor, controller, arithmetic logic unit (ALU), digital signal processor, microcomputer, field-programmable gate array (FPGA), programmable logic unit (PLU), microprocessor, or any other device capable of executing and responding to instructions. The processing device may execute an operating system (OS) and one or more software applications running on the OS. Additionally, the processing device may access, store, manipulate, process, and generate data in response to the execution of software. For ease of understanding, a single processing device is described, but those skilled in the art will recognize that the processing device may include multiple processing elements and/or multiple types of processing elements. For example, the processing device may include multiple processors or a combination of a processor and a controller. Furthermore, other processing configurations, such as parallel processors, are also possible.

The software may include computer programs, codes, instructions, or any combination thereof, which configure the processing device to operate as desired or collectively command the processing device. The software and/or data may be embodied in any type of machine, component, physical device, computer storage medium, or device to be interpreted by the processing device or provide instructions or data to the processing device. The software may also be distributed across network-connected computer systems and stored or executed in a distributed manner. The software and data may be stored on one or more computer-readable recording media.

The methods according to the embodiments may be implemented in the form of program instructions that can be executed through various computer means and may be recorded on a computer-readable medium. In this case, the medium may continuously store the program executable by a computer or temporarily store it for execution or download. Moreover, the medium may include various recording or storage means formed by combining single or multiple hardware components, and it may not be limited to media directly connected to a computer system but also include media distributed across a network. Examples of media include magnetic media such as hard disks, floppy disks, and magnetic tapes, optical recording media such as CD-ROMs and DVDs, magneto-optical media such as floptical disks, and semiconductor memories such as ROM, RAM, and flash memory configured to store program instructions. Other examples of media may include recording or storage media managed by app stores or other software distribution sites or servers that distribute applications.

While the embodiments have been described above with reference to specific examples and drawings, those skilled in the art will appreciate that various modifications and variations are possible based on the above disclosure. For instance, the described technologies may be performed in a different order than described, and/or the components of the described systems, structures, devices, and circuits may be combined or arranged in different forms or replaced by other components or equivalents to achieve the desired results.

Accordingly, other implementations, embodiments, and equivalents thereof are within the scope of the appended claims.

What is claimed is:

1. A method of operating a receiver in a communication system in which at least one OFDM symbol is transmitted, each OFDM symbol including a cyclic prefix and a symbol body, the method comprising:
performing a Fast Fourier Transform (FFT) on intervals from each of a first start position, a second start position, and a third start position included in a received signal to a length of the symbol body, to generate a first FFT signal, a second FFT signal, and a third FFT signal for a specific OFDM symbol;
estimating a frequency offset for the specific OFDM symbol based on the first to third FFT signals.

2. The method of claim 1, wherein:
the first start position is an estimated start position at which the specific OFDM symbol is located in the received signal;
the second start position is a position leading the estimated start position by a predetermined time length; and
the third start position is a position lagging behind the estimated start position by the predetermined time length.

3. The method of claim 2,
wherein the predetermined time length is a length of the cyclic prefix.

4. The method of claim 1, wherein the estimating the frequency offset comprises:
performing an Inverse Fast Fourier Transform (IFFT) only on resource blocks belonging to a specific subchannel of each of the first to third FFT signals to generate first to third IFFT signals; and
estimating the frequency offset based on the first to third IFFT signals.

5. The method of claim 4,
wherein the estimating the frequency offset based on the first to third IFFT signals comprises estimating the frequency offset using a cyclic prefix region of the specific OFDM symbol and a region in the symbol body corresponding to the cyclic prefix region (hereinafter, a cyclic prefix corresponding region) in at least some of the first to third IFFT signals.

6. The method of claim 5, further comprising:
estimating a timing offset for the received signal;
wherein the first start position is an estimated start position at which the specific OFDM symbol is located in the received signal, the second start position is a position leading the estimated start position by a predetermined time length, and
the third start position is a position lagging behind the estimated start position by the predetermined time length; and
wherein the estimating the frequency offset using the cyclic prefix region and the cyclic prefix corresponding region comprises:
taking samples belonging to the cyclic prefix region and samples belonging to the cyclic prefix corresponding region from the second IFFT signal and the third IFFT signal, respectively, based on the estimated timing offset.

7. The method of claim 5, wherein the estimating the frequency offset using the cyclic prefix region and the cyclic prefix corresponding region comprises:
performing a cross-correlation on the cyclic prefix region and the cyclic prefix corresponding region; and
estimating the frequency offset based on a result of the cross-correlation.

8. The method of claim 4, further comprising compensating the first IFFT signal for the estimated frequency offset.

9. The method of claim 8, further comprising performing an FFT on the first IFFT signal compensated for the frequency offset to acquire a resource block of a subchannel.

10. The method of claim 9, wherein a size of the FFT performed on the first IFFT signal compensated for the frequency offset is smaller than a size of the FFT used to generate the first FFT signal.

11. The method of claim 9, further comprising performing resource demapping on the acquired resource block.

12. The method of claim 8, further comprising:
estimating a timing offset for the received signal; and
compensating the first IFFT signal compensated for the frequency offset for the estimated timing offset.

13. The method of claim 12, further comprising performing FFT on the first IFFT signal compensated for the timing offset to acquire a resource block of a subchannel.

14. The method of claim 1, further comprising estimating a timing offset for the received signal.

15. The method of claim 14, wherein the estimating the timing offset comprises estimating the timing offset based on at least some of the first to third FFT signals.

16. The method of claim 14, wherein the estimating the timing offset comprises estimating the timing offset based on a demodulation reference signal included in the received signal.

17. A receiving apparatus in a communication system in which at least one OFDM symbol is transmitted, each OFDM symbol including a cyclic prefix and a symbol body, the receiving apparatus comprising:
an FFT block configured to perform a Fast Fourier Transform (FFT) on intervals from each of a first start position, a second start position, and a third start position included in a received signal to a length of the symbol body, to generate a first FFT signal, a second FFT signal, and a third FFT signal for a specific OFDM symbol; and
a frequency offset estimation block configured to estimate a frequency offset for the specific OFDM symbol based on the first to third FFT signals.

18. The receiving apparatus of claim 17, wherein:
the first start position is an estimated start position at which the specific OFDM symbol is located in the received signal;
the second start position is a position leading the estimated start position by a predetermined time length; and
the third start position is a position lagging behind the estimated start position by the predetermined time length.

19. The receiving apparatus of claim 17, wherein the frequency offset estimation block comprises:
an IFFT block configured to perform an Inverse Fast Fourier Transform (IFFT) only on resource blocks belonging to a specific subchannel of each of the first to third FFT signals to generate first to third IFFT signals; and
a frequency offset calculation block configured to estimate the frequency offset based on the first to third IFFT signals.

20. The receiving apparatus of claim 19, wherein the frequency offset calculation block is configured to estimate the frequency offset using a cyclic prefix region of the specific OFDM symbol and a region in the symbol body corresponding to the cyclic prefix region (hereinafter, a cyclic prefix corresponding region) in at least some of the first to third IFFT signals.

21. The receiving apparatus of claim 20, further comprising a timing offset estimation block configured to estimate a timing offset for the received signal,
wherein the first start position is an estimated start position at which the specific OFDM symbol is located in the received signal, the second start position is a position leading the estimated start position by a predetermined time length, and the third start position is a position lagging behind the estimated start position by the predetermined time length; and
wherein the frequency offset calculation block comprises:
a segment extraction block configured to take samples belonging to the cyclic prefix region and samples belonging to the cyclic prefix corresponding region from the second IFFT signal and the third IFFT signal, respectively, based on the estimated timing offset; and
a frequency offset determination block configured to perform a cross-correlation on the cyclic prefix region and the cyclic prefix corresponding region and estimate the frequency offset based on a result of the cross-correlation.

22. The receiving apparatus of claim 19, further comprising a frequency offset compensation block configured to compensate the first IFFT signal for the estimated frequency offset.

23. The receiving apparatus of claim 22, further comprising:
a timing offset estimation block configured to estimate a timing offset for the received signal; and
a timing offset compensation block configured to compensate the first IFFT signal compensated for the frequency offset for the estimated timing offset.
